(19) United States
(12) Patent Application Publication
(10) Pub. No.: US 2007/0192407 A1
(43) Pub. Date: Aug. 16, 2007

(54) Apparatus and method for executing provisioning

(76) Inventors: Sung Yeol Kim, Seoul (KR); Jung Bae Kim, Seoul (KR)

Correspondence Address: THELEN REID BROWN RAYSMAN & STEINER LLP, P. O. BOX 640640, SAN JOSE, CA, 95164-0640, US

(21) Appl. No.: 11/587,064

(22) PCT Filed: Nov. 3, 2004
(86) PCT No.: PCT/KR04/02803

§ 371 Date: Oct. 20, 2006

(51) Int. Cl. G06F 15/16

(52) U.S. Cl. 709/203

(57) ABSTRACT

The present invention relates to an apparatus and method for executing provisioning in which integrally supervises and executes call information from a plurality of providers for providing particular services being connected to a server. This invention is comprised of a provisioning database, a client interface, a provisioning database interface, and a provider interface.

### TECHNICAL FIELD

The present invention relates to an apparatus and method for executing provisioning. More particularly this invention relates to a provisioning executing apparatus and method for standardizing service-providing servers (hereinafter, called as “web server”), such as a web server or DB managing server, and integrally managing the call information of each the providers.

### BACKGROUND ART

Recently, owing to the development of Internet-related technologies, the number of Internet service providers (ISPs) that provide a variety of services to the Internet users are increasing. Mostly, ISPs also provide various supplementary services related to a major service, in order to collect a lot of subscribers or because of a certain necessity. For example, Freechal or Daum, one of Korean portal sites, provides to subscribers a large number of services, such as a searching, an e-mailing, a community service, etc. As the ISP services become diverse and complicated, it is required that new services and management systems, which are integrated and systematic with regard to the maintenance of the conventional services, should be developed. However, in the case of modifying the conventional system for improving it or adding new services, it is necessary for the whole source to be revised. Therefore this disadvantageously causes the loss in finance and time.

### DISCLOSURE OF INVENTION

Technical Problem

The present invention has been developed to avoid the problems of the conventional web servers providing various services. Therefore it is an object of the present invention to provide a provisioning executing apparatus and method for standardizing providers which provide particular services to clients, and for efficiently performing changing conventional services or developing new services by integrally managing the call information of each the providers.

It is another object of the present invention to provide a provisioning executing apparatus and method for avoiding the duplication possibility in developing new services, raising the processing efficiency by securing prompt process, and real-time monitoring the processed log so as to resolve promptly the error occurring.

Technical Solution

Terminologies

Provisioning: a series of work flow from a stage that the Internet user requests a particular service from a web server to a stage that he or she receives the service from the web server.

Provider: a constituent module of a web server, which handles a particular service among the various services provided by the web server. For example, it includes a DB provider which is in charge of storing the personal information of web site subscribers, an AD provider which administrates the active directory, an exchange provider which is in charge of web mail servicing in the case of a web server providing a web mail service, and the like.

Provisioning client: a service-providing server (e.g., web server or DB administrating server), which requests the provisioning service to a provisioning apparatus according to the present invention.

To achieve the above objects, there is provided an apparatus for executing provisioning, which executes an assigned task by integrally managing call information from at least one provider being connected to a provisioning client and providing particular services, the apparatus comprising: a provisioning DB for storing standardized work flows to be processed at each the provider; a client interface, which receives a request for a provisioning task from the provisioning client and returns a result of the provisioning task; a provisioning DB interface for fetching, from the provisioning DB, data relating to the work flow requested by the provisioning client; and a provider interface for calling relevant providers in order for the called providers to perform the provisioning tasks according to the standardized work flows and for being returned a result from the called providers.

According to another feature of the present invention, there is provided a method for executing provisioning, which executes an assigned task by integrally managing call information from at least one provider being connected to a provisioning client and providing particular services, the method comprising steps of: standardizing work flows to be processed at each the provider and storing in a DB; receiving a request for a provisioning task from the provisioning client and fetching, from the provisioning DB, data relating to the work flow requested by the provisioning client; and calling relevant providers in order for the called providers to perform the provisioning tasks according to the standardized work flows and being returned a result from the called providers.

Advantageous Effects

The present invention has advantages in that: By developing standardized providers and executing a provisioning task by integrally managing the call information of each the providers, the duplication possibility in developing new services can be minimized and maintenance of or updating the provider, or adding a new provider can become quite easier.

Especially, the present invention is useful for a stereotyped business dealing with a large amount of data, such as adding a new subscriber or revising subscriber information and handling subscriber secession, etc.

### DESCRIPTION OF DRAWINGS

The above and other objects, features, and advantages of the present invention will become more apparent from the following description when taken in conjunction with the accompanying drawings, in which:

FIG. 1 is a block diagram showing an embodiment of the apparatus of the present invention,

FIG. 2 is an exemplified screen picture for defining the workflow of a provisioning task,

FIG. 3 exemplarily shows a table for defining the workflow of a provisioning task,

FIG. 4 explains the operation of the apparatus and method of the present invention,

FIG. 5 shows the storing flow of log and statistics information, and

FIG. 6 exemplarily shows the log information displayed on a screen.

### BEST MODE FOR INVENTION

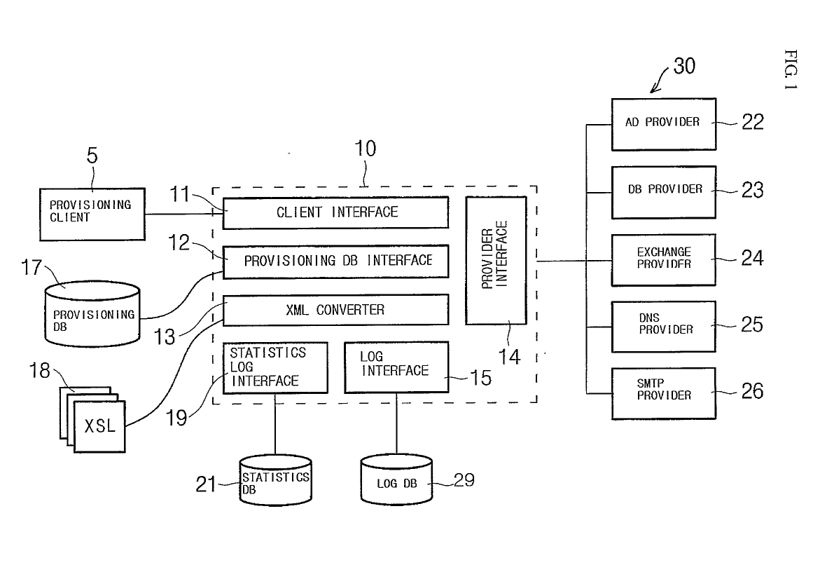

Hereinafter, a construction and operation of the present invention will be described in detail with reference to the attached drawings. As in FIG. 1, a provisioning client 5 for requesting a provisioning task, a provisioning server 10 for processing a provisioning task, and a plurality of providers 30 are interconnected through a network.

The provisioning client 5, which is actually a server for providing internet services, such as a web server of ISP or a DB managing server, requests a provisioning task from the provisioning server 10. A general web server may exclusively employ a provisioning server 10, or a plurality of web servers (i.e., provisioning client) may be connected to a provisioning server 10 for specially providing the provisioning task.

A plurality of providers 30 receive the information when the provisioning server 10 calls, and performs the called function in an orderly fashion and sends the result to the provisioning server 10, AD provider 22, DB provider 23, an exchange provider 24, DNS provider 25, SMTP provider 26 shown in FIG. 1 are merely exemplified ones. These may be changed according to a type of a service provided by the provisioning client 5, i.e., a web server, for requesting a provisioning task.

AD provider 22 manages e. g., Active Directory of MS Corporation. DB provider 23 is a provider that services management of a database. The exchange provider 24 is employed in a web mail servicing web server, and it performs a service of granting an e-mail account to a subscriber. DNS provider 25 is employed in a web server for servicing web hosting, and it performs a domain naming service. SMTP provider 26 performs an e-mail transmission service when a web server transmits an e-mail to subscribers. The above providers are developed standardizedly.

The provisioning server 10 is comprised of a client interface 11, a provisioning DB interface 12, XML converter 13, a provider interface 14, a provisioning DB 17, XSL file 18, a log creation module 15, a statistics log creation module 19, a log DB 27, and a statistics DB 21.

The provisioning DB 17 stores a standardized workflows which are to be processed by each the provider.

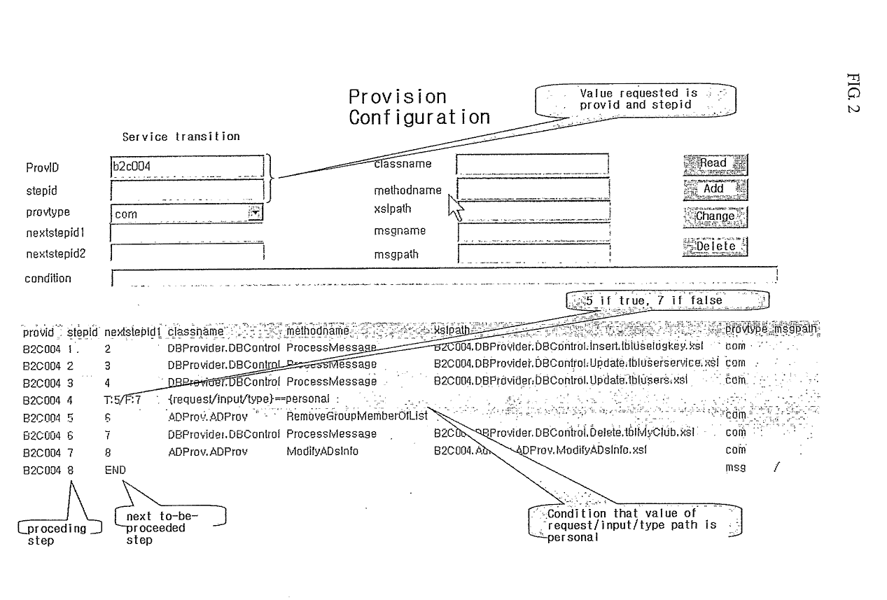

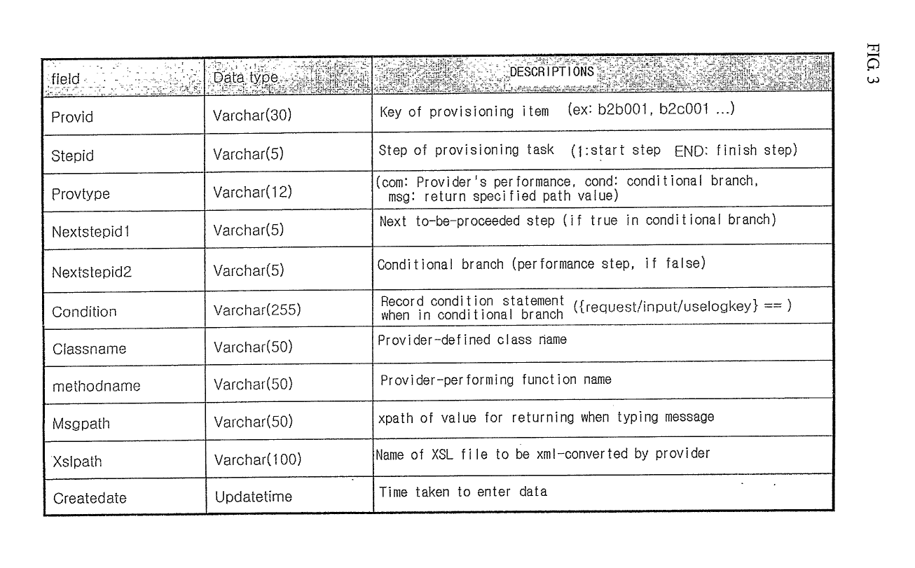

FIG. 2 is an exemplified screen picture for defining the standardized workflows, and FIG. 3 exemplarily shows a table listing the workflows stored in the provisioning DB 17. In FIG. 3, the work flows stored in the provider DB 17 include “Provid” field for defining a key of provisioning item, “Stepid” for a proceeding step of a provisioning task, “Nextstepidl” for a next to-be-proceeded step, “mehodname” for a function name to be performed by the provider, “Xslpath” for a name of XSL file to be xml-converted by each the provider, and the like. Like this, the provisioning task is processed as defined in the workflow table.

The contents of XSL file 18 is necessary for conversion of XML format. The XSL file 18 is used for XML converter 13 such that it provides information necessary to convert an inputting XML into another XML format each provider wants. That is, in the case different providers 30 use different types of XML language, the information stored in XSL file 18 is used when converting an XML format inputted by the provisioning client 5 into another XML format that each provider wants to use it for performing requested procedure.

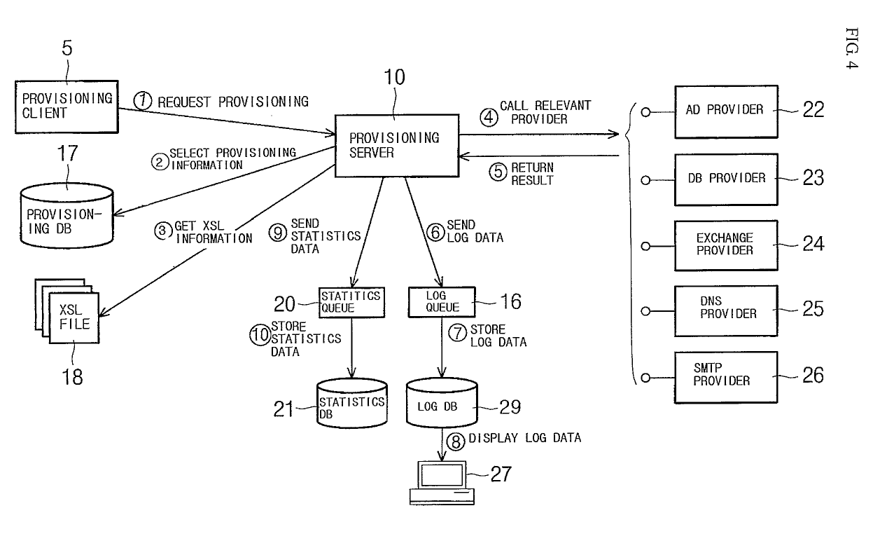

Now, with regard to FIG. 4, the operation of one preferred embodiment of the apparatus and method for executing provisioning according to the present invention will be described. If the provisioning client 5 requests a provisioning task from the provisioning server 10, the provisioning DB interface 12 of the provisioning server 10 fetches from the provisioning DB 17 the data relating to the work flow requested by the provisioning client 5.

For example, if, when a web server (the provisioning client 5) has a new subscriber who is requesting web mailing and web hosting services, the web server requests the provisioning task relating to that from the provisioning server 10, the provisioning DB interface 12 of the provisioning server 10 fetches the data necessary for processing the new user, the data being standardizedly stored by the DB provider 23, the exchange provider 24, and the DNS provider 25.

In the above example, in the case the service providers that the new subscriber specifies are using different type of XML languages, respectively, the XML converter 13 converts the input XML into another XML format that each provider wants, by using the pre-defined XSL file 18.

The provider interface 14 calls the relevant providers (in the above example, the DB provider 23, the exchange provider 24, and the DNS provider 25) by sending them the work flow data for each provider, which the provisioning DB interface 12 has fetched from the provisioning DB 17, and the XML input data that each provider wants, which has been converted by the XML converter 13. The called providers perform the work process according to the received workflow, and return the result to the provider interface 14.

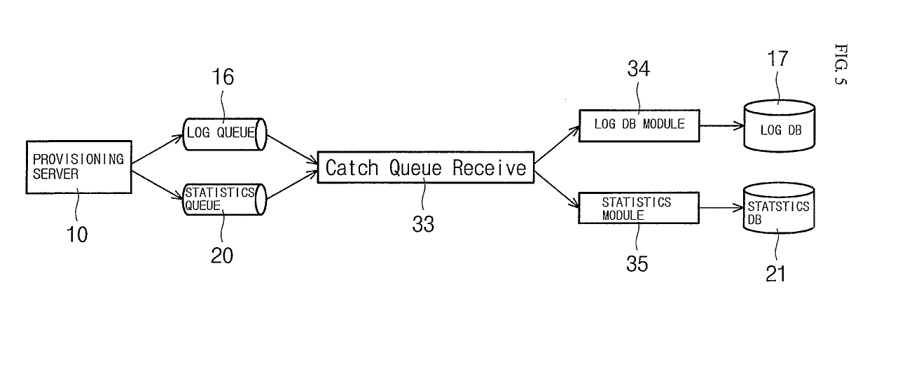

Log information created in the course of processing provisioning task is stored in the log DB 29, through the log interface 15. After all steps are ended, the information on process result is stored in the statistics DB 21, through the statistics log interface 19. FIG. 5 shows in detail the process of storing the log and the statistics log, respectively.

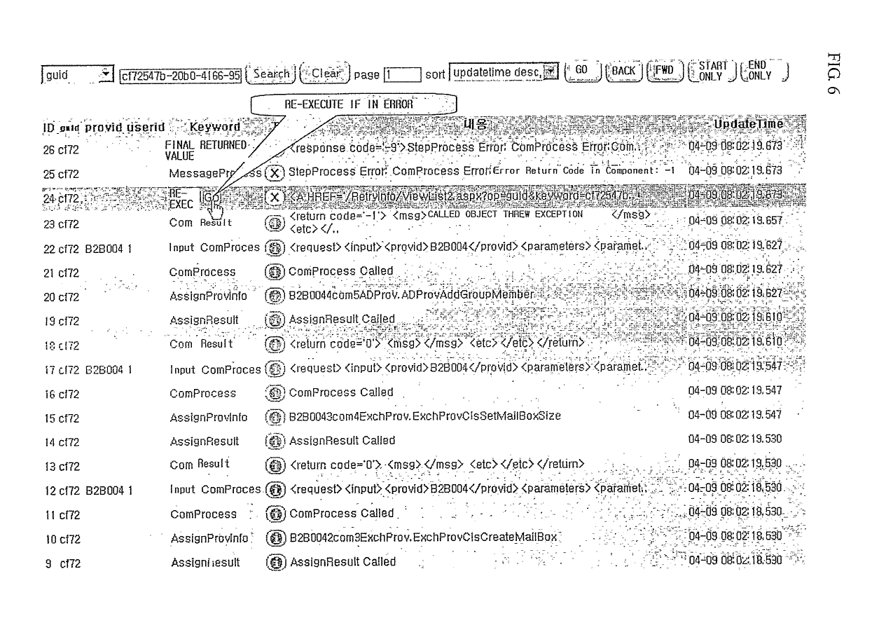

The log interface 15 of the provisioning server 10 transmits to a log queue 16 the log information produced at each provisioning steps. A catch queue receive 33 calls a log DB module 34 while receiving the message from the log queue 16, and the log DB module 34 stores the log information in a log table of the log DB 17. As shown in FIG. 4, it is preferable that the log information is displayed on a displaying device 27, so that an administrator can immediately monitor the provisioning processes. FIG. 6 shows the screen displaying the log information, which displays the result yielded at each provisioning step. If error is noticed, the error can be resolved or re-processed. Returning to FIG. 5, after the provisioning process ends, the statistics log interface 19 of the provisioning server 10 transmits to a statistics queue 20 the statistics log information. A catch queue receive 33 calls a statistics module 35 while receiving the message from the statistics queue 20, and the statistics module 35 processes the statistics information and stores the processed result in the statistics DB 21.

While the invention has been shown and described with reference to a certain embodiment to carry out this invention, it will be understood by those skilled in the art that various changes in form and details may be made therein without departing from the spirit and scope of the invention as defined by the appended claims.

### INDUSTRIAL APPLICABILITY

The present invention is applicable to a field, which includes providers servicing various services to Internet users, in ISP such as a web server or DB managing server.

1. An apparatus for executing provisioning, which executes an assigned task by integrally managing call information from at least one provider being connected to a provisioning client and providing particular services, the apparatus comprising:
a provisioning DB for storing standardized workflows to be processed at each the provider,
a client interface, which receives a request for a provisioning task from the provisioning client and returns a result of the provisioning task,
a provisioning DB interface for fetching, from the provisioning DB, data relating to the work flow requested by the provisioning client, and
a provider interface for calling relevant providers in order for the called providers to perform the provisioning tasks according to the standardized workflows and for being returned a result from the called providers.

2. The apparatus of claim 1, further comprising, if the providers use different XML languages,
means for storing at least one XSL file defining an XML language proper to each the provider, and
an XML converter for converting an input XML into another XML format proper to a provider in charge of processing the requested task, by using the defined XSL file read out from the XSL file storing means.

3. The apparatus of claim 1, further comprising:
a log creation module for creating log data produced during execution of a provisioning task,
a log DB for storing the log data created by the log creation module, and
a log display means for displaying the created log data.

4. The apparatus of claim 1, further comprising:
a statistics log creation module for creating statistics log data produced after execution of a provisioning task, and
a statistics log DB for storing the statistics log data created by the statistics log creation module.

5. The apparatus of claim 3, further comprising:
a statistics log creation module for creating statistics log data produced after execution of a provisioning task, and
a statistics log DB for storing the statistics log data created by the statistics log creation module.

6. A method for executing provisioning, which executes an assigned task by integrally managing call information from at least one provider being connected to a provisioning client and providing particular services, the method comprising steps of:
standardizing work flows to be processed at each the provider and storing in a DB,
receiving a request for a provisioning task from the provisioning client and fetching, from the provisioning DB, data relating to the work flow requested by the provisioning client, and
calling relevant providers in order for the called providers to perform the provisioning tasks according to the standardized workflows and being returned a result from the called providers.

7. The method of claim 6, further comprising steps of, if the providers use different XML languages,
reading out at least one XSL file defining an XML language proper to each the provider, and
converting an input XML into another XML format proper to a provider in charge of processing the requested task.

8. The apparatus of claim 6, further comprising steps of:
creating log data produced during execution of a provisioning task,
storing in a DB the log data created by the log creation step, and
displaying the created log data.

9. The apparatus of claim 6, further comprising steps of:
creating statistics log data produced after execution of a provisioning task, and storing in a DB the statistics log data created by the statistics log creation step.

10. The apparatus of claim 8, further comprising steps of:
creating statistics log data produced after execution of a provisioning task, and
storing in a DB the statistics log data created by the statistics log creation step.
